(19) United States
(12) Patent Application Publication
(10) Pub. No.: US 2006/0123355 A1
(43) Pub. Date: Jun. 8, 2006

(54) Information analysis method

(75) Inventors: Dale W. Christiansen, Blackfoot, ID (US); Samuel Ramirez, Rigby, ID (US)

Correspondence Address: Alan D. Kirsch, P.O. Box 1625, Idaho Falls, ID, 83415-3899, US

(73) Assignee: Bechtel BWXT Idaho, LLC

(21) Appl. No.: 10/966,631

(22) Filed: Oct. 14, 2004

(51) Int. Cl. G06F 3/00

(52) U.S. Cl. 715/781

(57) ABSTRACT

An information analysis method is described and which includes steps of providing a data analysis framework for selectively holding a plurality of interrelated computer viewable views of selected data; interacting the plurality of computer viewable views; and evaluating the plurality of computer viewable views substantially simultaneously.

### GOVERNMENT RIGHTS

This invention was made with Government support under Contract No. DE-AC07-99ID13727 between Bechtel BWXT Idaho, LLC and the U.S. Department of Energy.

### TECHNICAL FIELD

The present invention relates to an information analysis method and more specifically to a computerized data analysis method and which is operable to store, process, and present various representations of high volumes of data in multiple, customizable and interrelated views, and which facilitates the analysis of the data which is displayed.

### BACKGROUND OF THE INVENTION

In some industry segments, analysts are often utilized to review high volumes of data in order to see trends, patterns, details, and hidden relationships, and which may significantly impact the operation of a given business. For example, cyber security specialists who are tasked with the responsibility of maintaining large and sophisticated computer networks often have the enormous task of reviewing significant volumes of information relative to their network, and then by a very time consuming process of submitting linear queries, reduce the volumes of data down to effective subsets or terms whereby analysis can be conducted on same. In view of the increased sophistication of computer network attacks which are being perpetuated by highly sophisticated individuals, analysts need a quick and effective way that they can filter, process and review large volumes of data in order to effectively identify trends and patterns, as well as details, and hidden relationships which could readily prevent such attacks.

An information analysis method which achieves these and other objectives is the subject matter of the present invention.

### SUMMARY OF THE INVENTION

A first aspect of the present invention relates to an information analysis method which includes the steps of providing a data analysis framework for selectively holding a plurality of interrelated computer viewable views of selected data; interacting the plurality of computer viewable views; and evaluating the plurality of computer viewable views substantially simultaneously.

Another aspect of the present invention relates to an information analysis method which includes the steps of defining a database having information from various sources, and wherein the information from the various sources can be displayed in a plurality of different computer viewable formats; selecting a plurality of parameters which are common to the information which has been derived from the various sources; and interrelating the different formats, and the plurality of parameters in a fashion so as to permit a user to display selected related information derived from the variety of different sources in a plurality of different formats.

Yet further, another aspect of the present invention relates to an information analysis method which includes the steps of providing an application server; providing a database server; providing a software registry and coupling the software registry in data exchanging relation relative to the application and database servers; providing a web browser and coupling the web browser in data exchanging relation relative to each of the application and database servers, and wherein a user may remotely access the application and database servers by employing the web browser; defining a database within the database server and which includes information from various sources, and wherein the information from the various sources can be displayed in a plurality of different computer viewable formats; identifying a plurality of parameters which have a relationship with at least some of the information which is derived from the various sources, and at least some of the plurality of computer viewable formats; selecting the desired computer viewable formats for displaying the information from the various sources; subscribing selected ones of the plurality of computer viewable formats to the software registry; retrieving the selected ones of the parameters that are required by the individual computer viewable formats to display the information from the various sources; interacting with at least one of the plurality of parameters and/or plurality of computer viewable formats to change the parameter and/or the computer viewable format; updating the software registry as needed to reflect the change in at least one of the parameters and/or computer viewable format; and changing the respective computer viewable formats which are affected by the change in the at least one of the parameters and/or computer viewable formats.

These and other aspects of the present invention will be discussed in further detail hereinafter.

### BRIEF DESCRIPTION OF THE DRAWINGS

Preferred embodiments of the invention are described below with reference to the following accompanying drawings.

FIG. 1 is a high level organizational schematic illustration of the present invention.

FIG. 2 depicts a typical end user's computer for accessing the information analysis method of the present invention.

FIG. 3 is a high level schematic representation of another aspect of the present information analysis method.

FIG. 4 is a greatly simplified depiction of a computer viewable view which is generated by the information analysis method of the present invention.

FIGS. 5A and 5B represent two alternative computer viewable views which may be provided by the information analysis method of the present invention.

FIG. 6 is yet another computer viewable view produced by the information analysis method of the present invention.

FIG. 7 is a greatly simplified high level schematic representation of another aspect of the present invention.

FIG. 8 is a greatly simplified depiction of six (6) computer viewable views which may be provided by the information analysis method of the present invention.

FIGS. 9A and 9B are yet further greatly simplified depictions of computer viewable views that may be produced by the information analysis method of the present invention.

FIG. 10 is a greatly simplified depiction of subsequent computer viewable views which may be provided by the method of the present invention.

FIG. 11 is still further a greatly simplified schematic representation of an aspect of the information analysis method of the present invention.

FIG. 12 is a greatly simplified depiction of a computer viewable view produced by the method of the present invention.

FIG. 13 depicts several computer viewable views produced by the method of the present invention and the relationship of those views with a portion of the computer architecture of the present method.

FIG. 14 depicts yet a further computer viewable view produced by the method of the present invention.

FIGS. 15-24 depict alternative sequential computer viewable views as provided in the method of the present invention and their relationship with portions of the computer architecture of the present method.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Throughout the detailed description which is provided hereinafter, the information analysis method of the present invention is described or further explained by reference to a cyber security example illustration. However, while this example is used to further explain the broad features of the invention, it will be understood, by those skilled in the art, that this information analysis method is not confined to this specific use and may be utilized in various industry segments beyond cyber security. Therefore, while these examples are being employed, they should not be viewed as limiting examples, but rather merely employed for illustrating the broad aspects of the present invention.

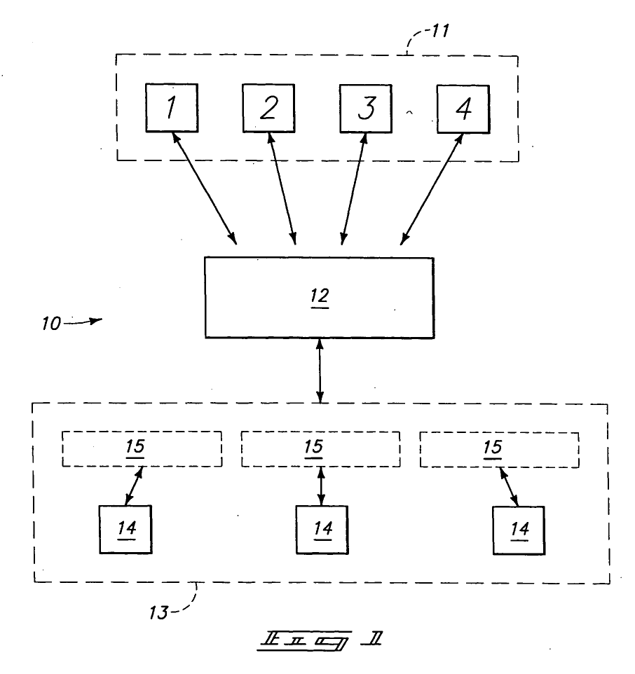

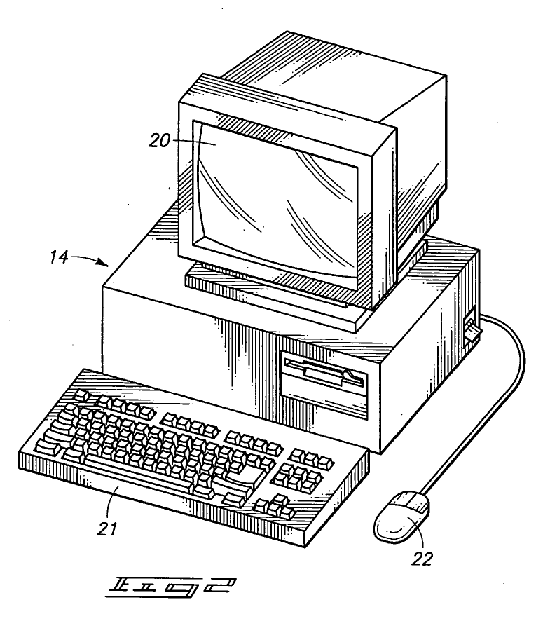

Referring now to FIG. 1, the information analysis method 10 of the present invention is generally shown in a high level organizational diagram which illustrates several features of the present invention. More specifically, FIG. 1 shows one possible computer architectural configuration which the present invention can operate in. It should be understood that other architectural configurations will work with equal success. In this regard, the high level organizational diagram as shown in FIG. 1 illustrates that a plurality of resource providers, which are generally indicated by the numeral 11, (and which are labeled 1-4) are coupled in data exchanging relationship with a host server which is generally indicated by the numeral 12. In the context of this patent application, the term resource providers will be understood to include single or multiple companies, agencies or other sources from which data and/or other records originate. The structure of the host server 12 will be discussed in greater detail hereinafter. As a general matter however, the host server, comprises a computer, as will be described hereinafter, and which constitutes a hardware platform which executes data instructions to implement the present invention 10, as well as interfacing with a plurality of customers which are generally indicated by the numeral 13. The customers 13 which utilize the method of the present invention may further utilize a plurality of computers 14 which may be used by analysts (not shown). The customer computers 14 are all equipped with standard web browsers 15 which couple the computers in data exchanging relation relative to the host server 12. Those skilled in the art should understand that the web browser 15 provides a required software interface between the host server and the customers' respective computers 14. This specific software, which will typically be utilized for that interface is the World Wide Web browser which is well known in the art. The customers' respective computers 14, as seen in FIG. 2 includes, among other components, a video monitor, which is generally indicated by the numeral 20 and which is electrically coupled with the computer 14. A keyboard 21 is provided, and which is coupled to the computer 14. Still further, a pointing device is provided and which is generally indicated by the numeral 22. The computer 14 as seen in FIG. 2 may also include additional software interfaces with other customer computers and server computers (not shown) over a network interface. This will permit the various computers 14 to send and retrieve messages, manage data files and browse for information. Computers 14 such as seen in FIG. 2 also have limited capability to process data and interact with the user independent of the server 12 from which it is coupled in data exchanging relation.

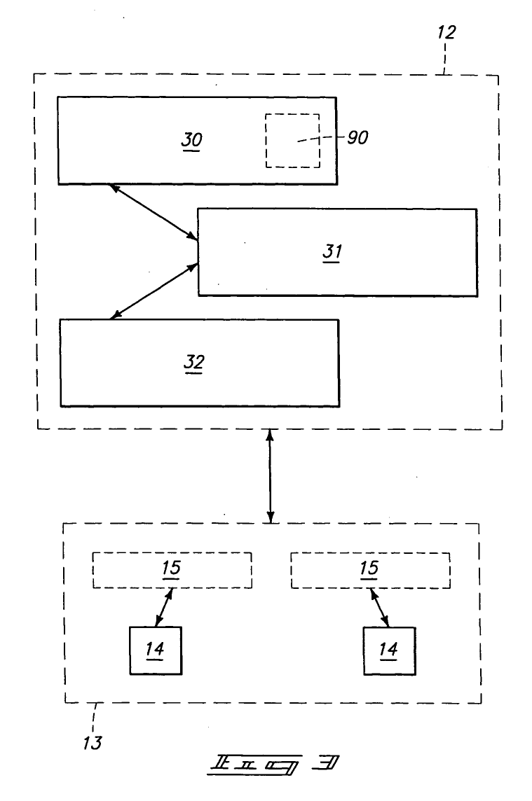

Referring now to FIG. 3, it will be understood that coupling the server 12 with a customer computer 14 provides the customer 13 with greater capability. As should be understood, typical server architecture includes, but is not limited to, terminal servers, name servers, mail servers, message servers, transaction servers, directory servers, file servers, and the like. For purposes of the present invention, the host server 12 comprises for the present method 10 a database server 30; an application server 31 which is coupled in data exchanging relation therewith; and a web server which is generally indicated by the numeral 32. The web server 32 is operable to respond to simultaneous requests which are provided from one to many of the customer's 13, web browsers 15, by way of a HTTP protocol. In this regard, the web server 32 responds with the requested data by means of a URL. As a general matter, most web servers 32 have a limited data processing and logic capacity. In most instances, the web server 32 can only perform static file retrieval from a local file system and respond with the data contained in the retrieved file. As seen in FIG. 3, the web server 32 is coupled in data exchanging relation relative to the application server 31. The application server in the arrangement as shown in FIG. 3 may contain all the logic capability to engage in the complexities of the present invention 10. As a general matter, however, the application server 31 resides, computer architecturally speaking, between the web server 32 and the database server 30 as shown in FIG. 3. This particular computer architectural arrangement includes software interfaces, which permits the exchange of data services in a standard efficient, scalable, distributed, decoupled and industry accepted way. The database server 30 as seen in the arrangement of FIG. 3 stores and retrieves data which is usually formatted in structured, entity relationships. The storing and retrieval process involves using an application-program interface and/or language to create, read, update or delete the data. The database server as seen provides the ability to store, manage, protect and allow access to the data.

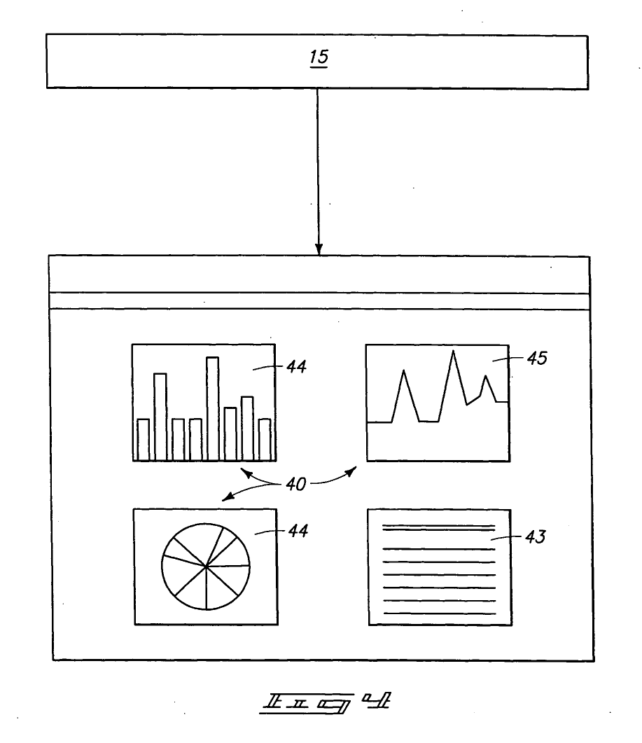

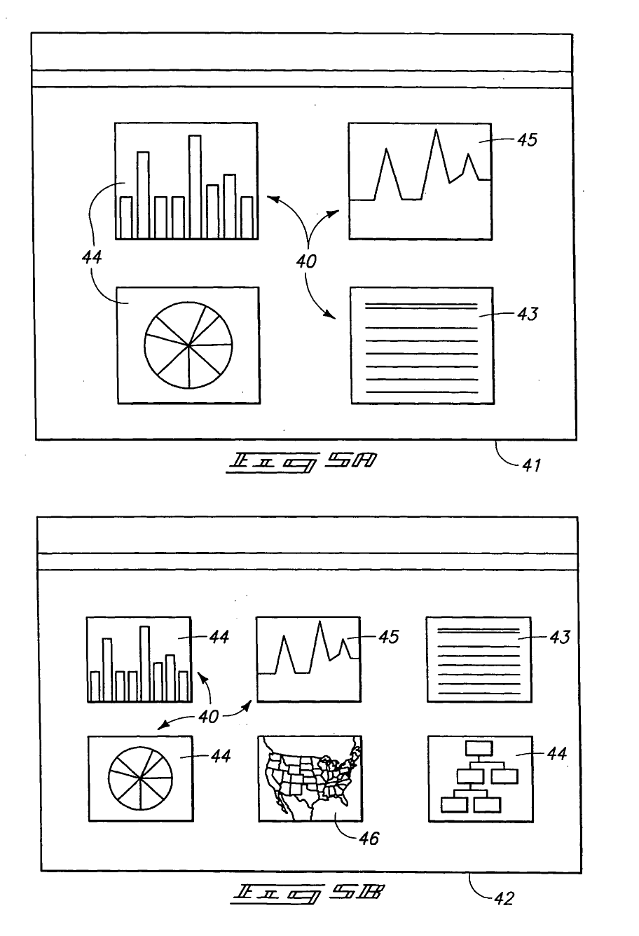

Referring now to FIG. 4 and following, an overview of the methodology 10 of the present invention is shown with respect to several greatly simplified computer screens as might appear on a customer's video monitor 20 when implementing the present methodology. With respect to FIG. 4, it will be understood that the information analysis method in it's broadest aspect includes the step of providing a plurality of computer viewable views 40; interacting with the plurality of computer viewable views as will be seen hereinafter by utilizing the pointing device 22 or keyboard 21, and evaluating the plurality of computer viewable views substantially simultaneously. As seen in FIG. 4 which is a simplified graphic depiction of what would be viewed on the video monitor 20 of a customer computer 14, the plurality of computer viewable views 40 include a predetermined number, and layout of the respective views which is configurable for each customer 13 based upon a selected profile as might be seen in FIGS. 5A and 5B, respectively. FIG. 5A shows a first user or customer profile 41, and a second user or customer profile 42 is shown in FIG. 5B. The plurality of computer viewable views 40 may include but are not limited to lists 43; charts 44; graphs 45; and maps 46 among many others.

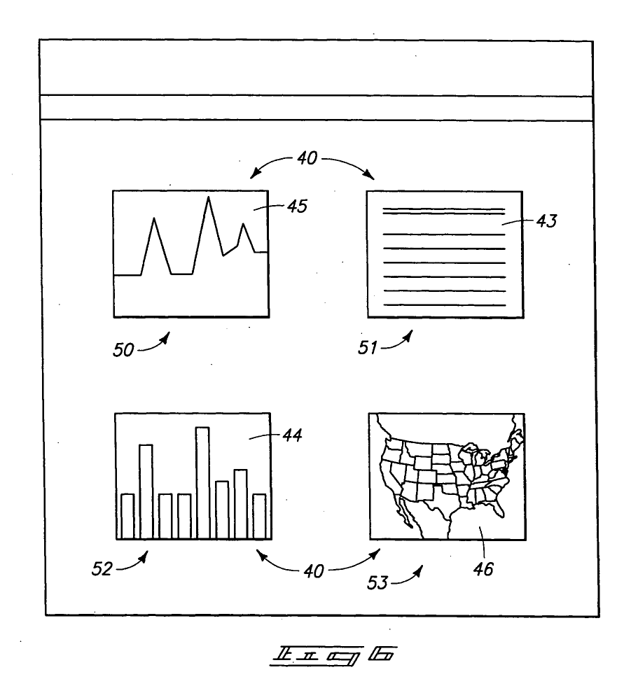

Referring now to FIG. 6 which again shows the video display of a monitor 20, a non-limiting example of one aspect of the present invention 10 is depicted. By way of example, in a cyber security application, a cyber security intrusion and detection analyst may require view 50 showing a line graph 45 which shows the number of attacks on a certain protocol occurring over a time span of, for example, a week; while a related view 51 will show a list 43 of the attack signatures which were involved in these intrusion attempts. A third view 52, may be provided and which charts 44 the sensors and activity involved in such intrusion attempts; and a fourth view 53 may show a map 46 of the attack locations. In the arrangement as shown in FIG. 6, each of the computer viewable views 40 shows unique data, yet each is related to the others by common parameters 60 which will be discussed in the paragraphs below. In the arrangement as shown, the plurality of computer viewable views are able to interact, not only with the customer 13, but also with the other views that are open and are seen on the computer monitor 20.

Referring now to FIG. 7, the methodology of the present invention 10 includes software which resides on the application server 31, and which manages the relationships between common parameters 60 which are common to the various computer viewable views 40 which are seen and can be displayed on the computer monitor 20. The methodology of the present invention 10 includes a step of providing an overall software registry 61 wherein each of the computer viewable views 40 are subscribed thereto along with the parameter 60. The registry 61 provides, in part, a publish/subscribe interface 62 for each of the several computer viewable views 40. In the arrangement as shown, the common parameters 60 are registered in the registry 61 for later retrieval and notification among the several computer viewable views 40 as seen on the computer monitor 20. As should be understood, in the methodology 10 of the present invention, when a customer 13 makes changes 63 to the values, and the common parameters 60, these subsequent values are then published to each of the several computer viewable views 40, and updated substantially simultaneously. Still further, the customer 13 may implement further changes 64 based upon their own needs. It will be recognized that if the user or customer 13 changes a computer viewable views' parameters 60, and one of those parameters is in the registry 61, and the same view 40 is currently subscribed to, the value of the parameter is reported to the registry. The registry, then in response, and if configured, will publish that revised or updated value to other computer viewable views 40 that are subscribed to for this specific parameter and its associated value. All computer viewable views will then update themselves based on the newly acquired parameters 60. As seen in FIG. 7, it will be understood that the computer viewable views that are provided 40 may include a drill down view 65 which provides further detail with respect to specific data points as provided in one of the several computer viewable views 40. Each of the computer viewable views as seen in FIG. 7 are coupled in data exchanging relation relative to the registry 61.

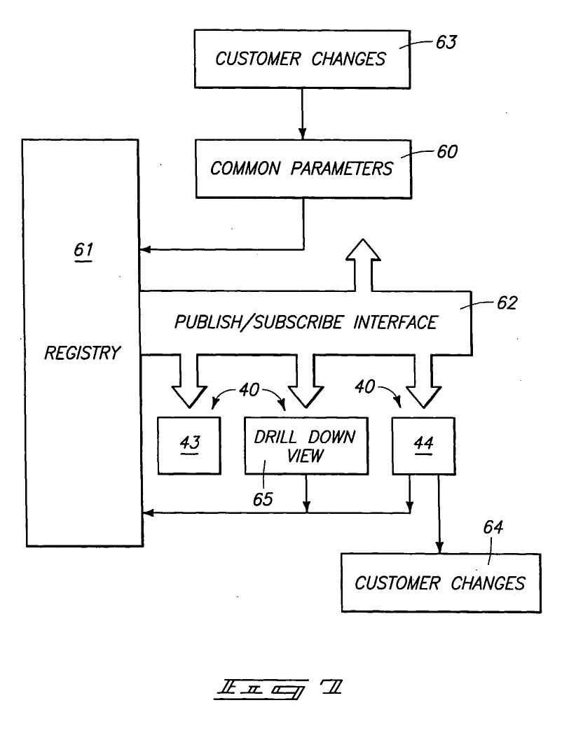

Referring now to FIG. 8 which shows examples of three computer viewable views 40 that could be conceivably displayed, on a customer's 13 monitor 20, it will be seen that the methodology of the present invention 10 dynamically links the several computer viewable views 40 to provide the customer 13 with greater flexibility with respect to analyzing data. In continuance of the non-limiting example of cyber security, and as seen in FIG. 8, the computer viewable views 40 may include the number of attacks 50 on a certain protocol, and where this same data, for a given time span, is shown in a graphic form 45. An area of interest of that graph is circled and is indicated by the arrow 70. As seen in FIG. 8, the related dynamically linked views include a list 43 of related data such as signatures 51; and a map 46 of the associated attack sources and targets 53. In the illustration as seen in FIG. 8, when the customer 13 uses the pointing device 22, or keyboard 21, and clicks or executes on a given data point as contained within the circled area 70, all the computer viewable views 40 refresh themselves to show a more narrow time window which is the subject of the data query made by the customer 13. Therefore, in FIG. 8 it will be understood that the graph 50, showing the number of attacks, refreshes to show a more narrow time window and further displays greater detail for a smaller number of attacks. Still further, the computer viewable views which shows the attack signature 51 provides greater detail of just those signatures relevant to the time span in question. Still further, the computer viewable views 53 shows a more focused location associated with the smaller data set which is provided for in the data query 70. As noted above, the data query may be made by the pointing device 22, keyboard 21 or similar assembly.

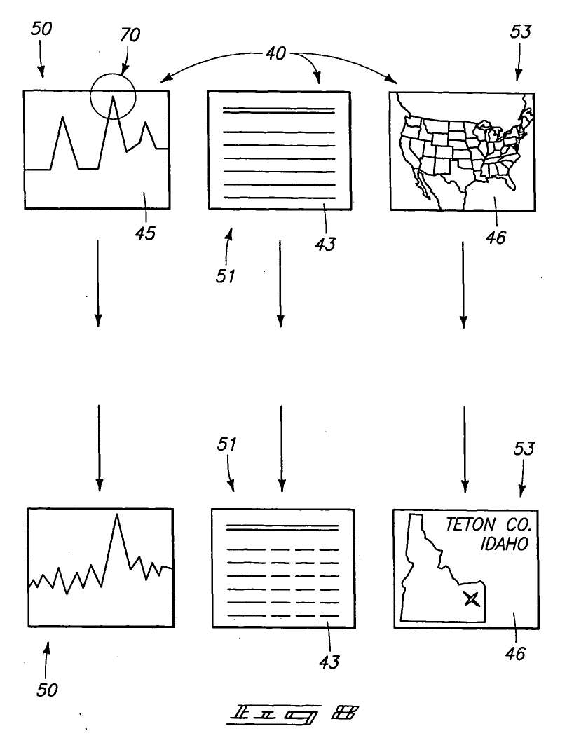

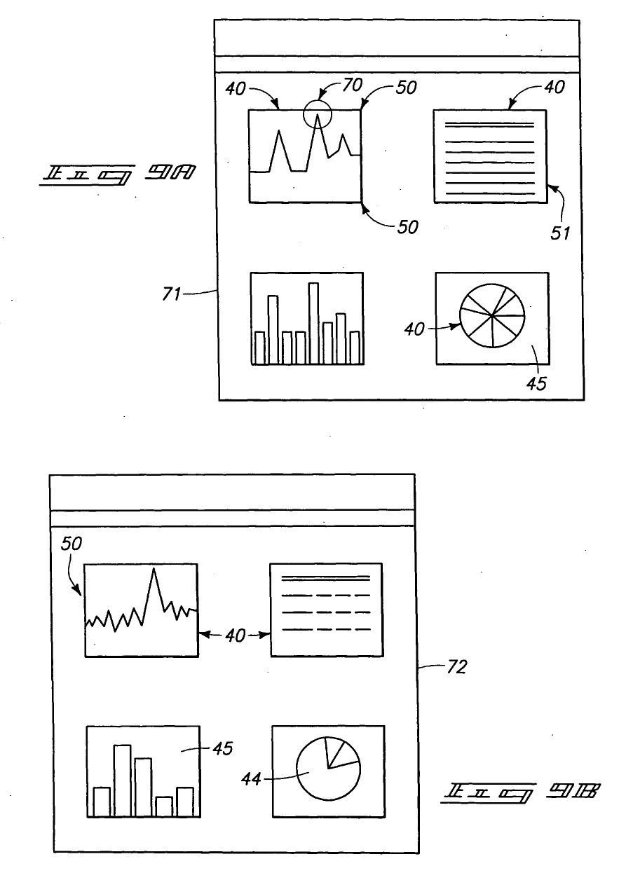

Referring now to FIGS. 9A and 9B which illustrates the customer's 13 screen of their computer monitor 20, it will be understood that the plurality of computer viewable views 40 which are displayed thereon would have a first screen configuration 71. However, upon querying as indicated by the arrow labeled 70, a second customer screen 72 would been seen and which would have the greater detail and shorter time periods as discussed above.

Referring now to FIG. 10, each of the computer viewable views 40 may provide further analysis by providing a drill down view 65 as seen in FIG. 10 on a certain data point within a list 43 or chart 44. This drill down view can also be reported to the registry 61 for publishing to the other views 40 as earlier discussed.

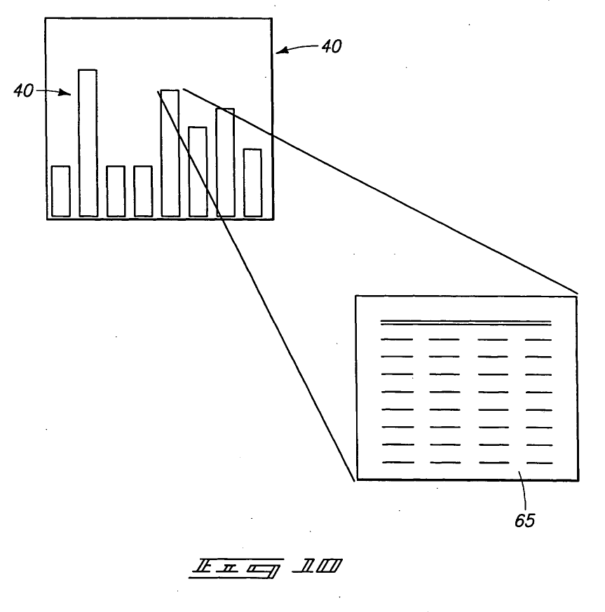

Referring now to FIG. 11, the levels of security as provided for in the methodology of the present invention 10 includes, at a first level, an interface level whereby improper access is initially prevented based on navigation and web form access, and which typically is controlled by a password generally indicated by the numeral 80. This security measure is driven typically from the application server 31 configuration, and any database tables which are contained within the database server and databases contained therein which will be discussed below. This first level of security is typically managed by a system administrator. This first level of security is intended to prohibit access to forms, for example whereby the customer 13 has no privileges, although they may have a right to retrieve or receive data contained within such forms. At a second level of security, access for any person or customer 13 is secured by a standard authentication and authorization service. The user is authenticated against encrypted credentials 82 which are stored in a database which are contained on the database server 30. Once the person or customer 13 is authenticated, the customer's roles which are also stored in such a database, as will be described below, are cached, and then later used to apply authorization to gain access to each of the computer viewable views 40. In this regard, menu options that a customer 13 may see are also controlled by assignment of these various roles. At a third level of security, that is, from the web browser 15 to the web server 32, confidentiality is typically implemented with a standard HTTP security technique 81 such as secure HTTP or other standard encryption which is well understood in the art. As seen in FIG. 11, the database server 30 includes a database 90 which holds or contains a plurality of data which is useful in producing the various computer viewable views 40 which are seen on the monitor 20 of the customer's 13 computer 14.

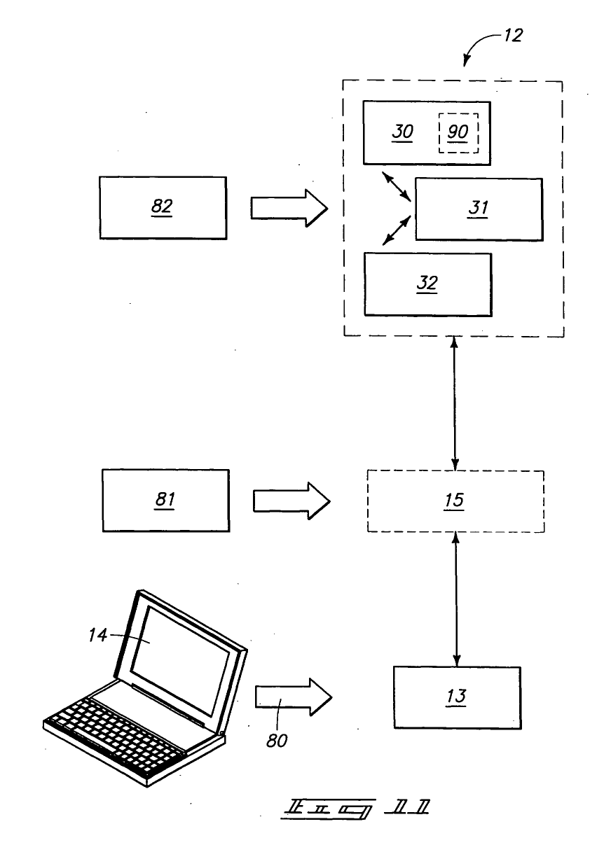

Referring now to FIG. 12, and upon execution of the application which resides on the application server 31, and which contains the methodology of the present invention, a customer 13 is presented with several computer viewable views 40 within an application framework 91, and which is coupled in data exchanging relation relative to the database 90. Within the application framework 91, a common block of parameters 60 are provided that may, or may not have relationships to the various computer viewable views 40. These views are all contained within the application framework which is contained within a standard web browser 15, which is not shown in all the remaining drawings (FIGS. 13-24). Referring now to FIG. 13, it will be seen that the computer viewable views 40 of FIG. 12 are first accessed when the customer 13 opens the software which implements the methodology 10 from a menu which is generally indicated by the numeral 92. This act of opening the application causes the software which resides in the application server 31 to retrieve settings from the database 90, retrieve the registry 61 from the webserver 32 which is initialized for later publishing and subscribing, and configures and displays several of the computer viewable views 40 within the application framework 91 as provided by the web browser and which is best seen in FIG. 12.

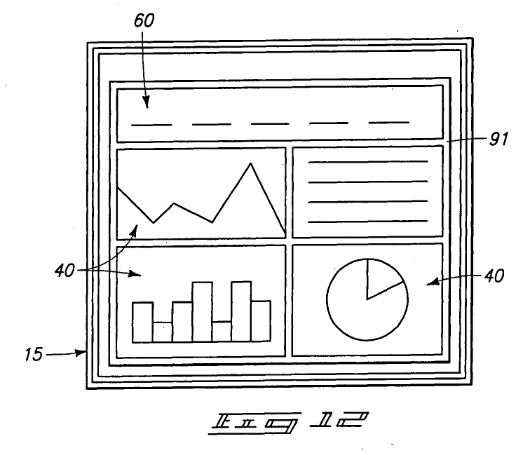

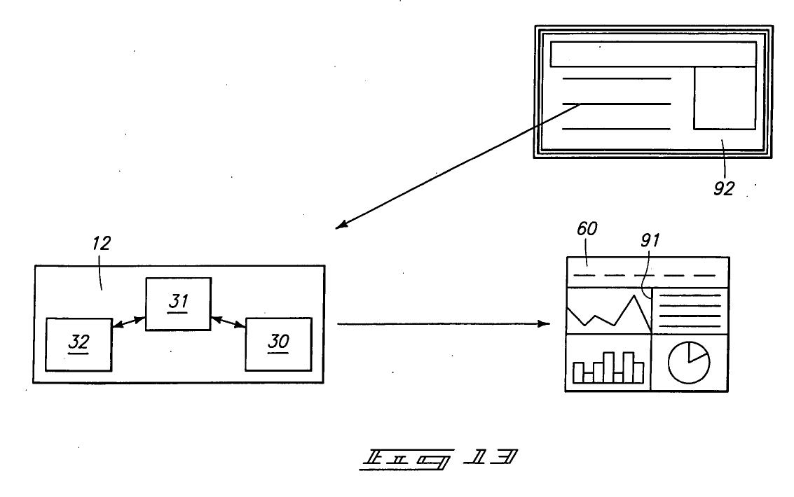

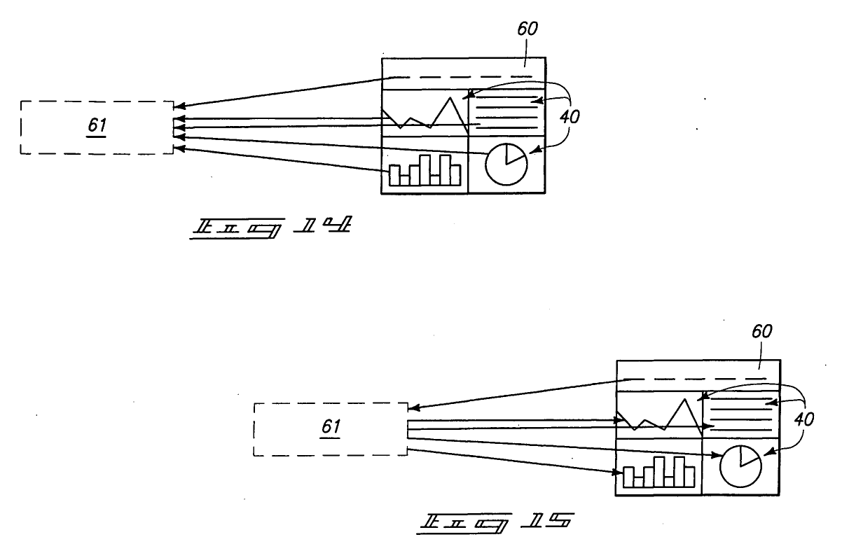

Referring now to FIG. 14, upon execution of the methodology 10 of the present invention, the relationships between the several computer viewable views 40 and the parameters 60 subscribe to the registry 61. Referring now to FIG. 15, on the first execution, the several views 40 are then notified by the registry 61 that the common block parameters 60 have values. Referring now to FIG. 16, when each of the computer viewable views 40 are notified, the respective computer viewable views retrieve the common block parameter 60 values that are required for its own purposes. Referring now to FIG. 17, as soon as the respective computer viewable views 40 retrieves all the individual parameters 60 required for their use, the respective computer viewable views 40 update themselves using the new parameters 60 to present new information which may be analyzed by the customer 13. Each of the respective computer viewable views 40 updates itself by submitting the values to an available application server 31 that will service the specific request for information. It should be understood that each of the respective computer viewable views 40 updates itself asynchronously so that some of the computer viewable views 40 may present their information immediately while others, which require a longer processing time to come up, are presented later in the process. Typically, however, the respective views are presented by quick execution time by means of the application server 31. When each of the respective computer viewable views 40 has received the requested information from the application server 31, the customer is presented with multiple computer viewable views 40 that contain information relative to the preconfigured parameter 60 which may or may not be holding a default value. In this regard, the application server 31 retrieves data from the database 90 and updates each of the respective computer viewable views 40.

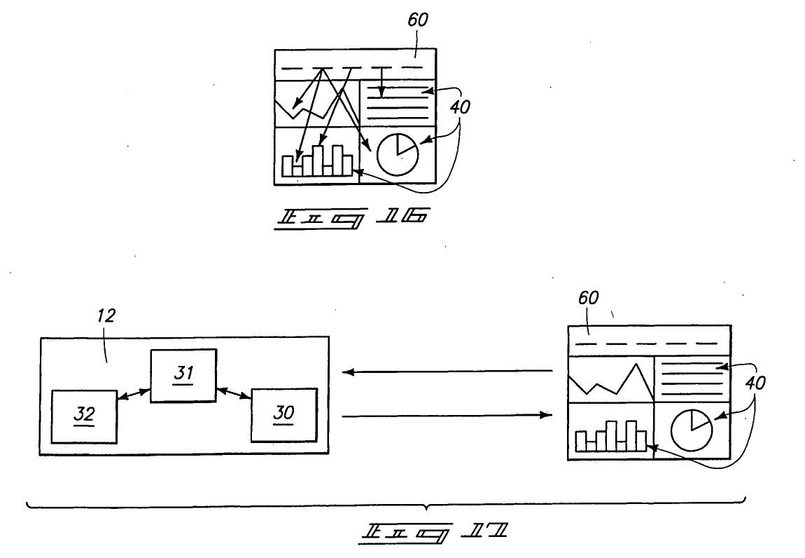

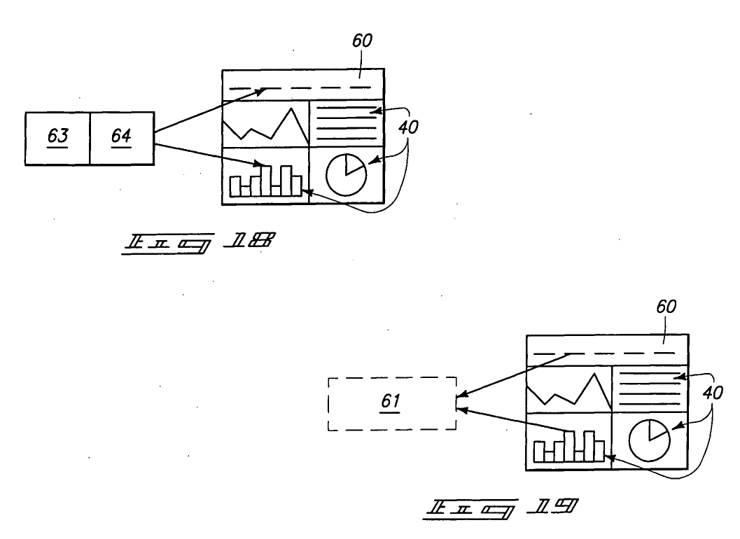

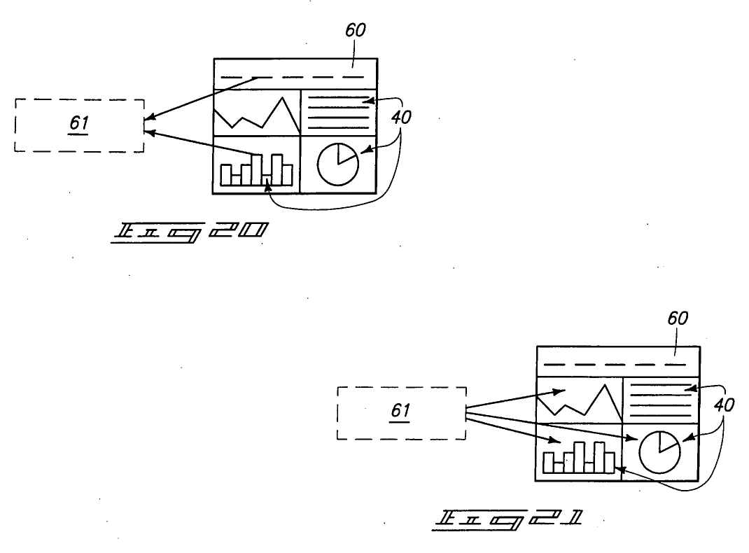

Referring now to FIG. 18, the customer 13 can now interact with each of the computer viewable views 40 or with the individual common block parameters 60. This may be done by means of the customer 13 changing the views 64, or the customer changing the various parameters 63 (FIG. 7). Referring now to FIG. 19, it will be understood that the software registry 61 is working to keep track of the computer viewable views 40/parameter relationships 60 and to perform various notifications as needed. In this regard, if the customer 13 changes a value in the common block parameter 60, the change is noted in the registry as shown in FIG. 19. These values and selections are checked for relevant changes. Referring now to FIG. 20, after the customer changes one or more of the common block parameters 60, these values are submitted to the registry 61 to check if the value is indeed changed. Referring now to FIG. 21, after the customer 13 changes one or more of the common block parameters values 60 and those values are checked in the registry 61, the registry 61 then decides which of the computer viewable views 40 are effected based on those parameter values 60 which have been changed. If the parameter 60 is related to one or more of the computer viewable views, those computer viewable views 40 are modified as appropriate.

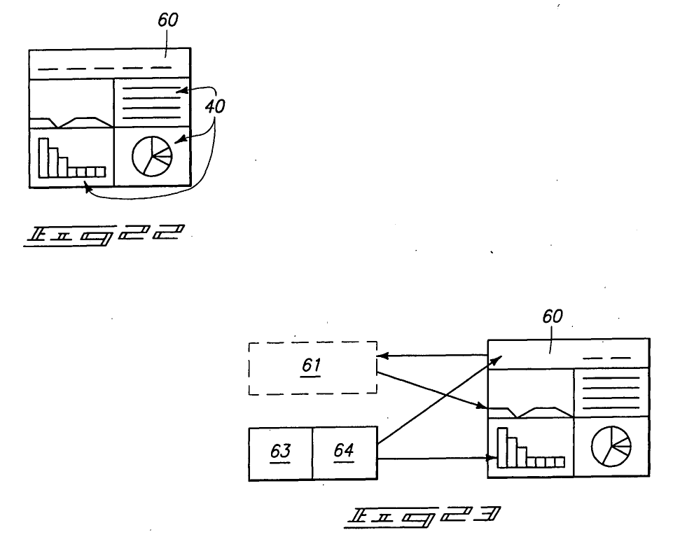

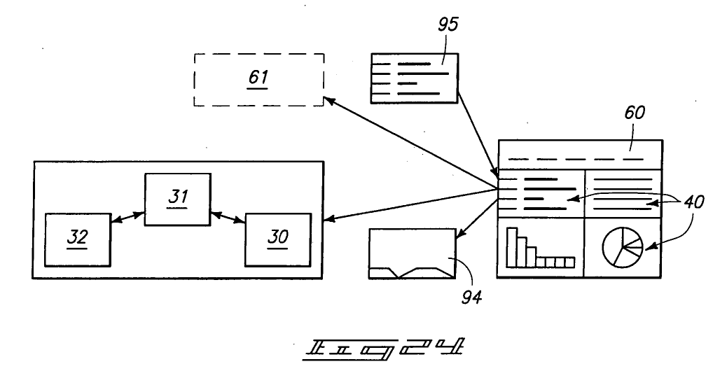

Referring now to FIGS. 21 and 22, all effected computer viewable views or formats 40 are subsequently flagged to be notified. This is done so that if a computer viewable view or format 40 contains more than one parameter 60 that has been changed, the computer viewable view or format 40 is not notified more than once. Once the effected views are determined, the registry notifies them as seen in FIG. 21. The user 13 is then presented with a different set of information if the affected parameter 60 caused data changes within the respective computer viewable views as seen in FIG. 22. Referring now to FIG. 23, it will be seen that the customer 13, by implementing customer changes 63 to the common parameters 60 or customer changes to the views 64 interact with the respective views and common parameter blocks as seen. If the customer 13 decides to change the view parameters 60, the change is made in the respective computer viewable views 40, and the related common block parameters 60 as seen in FIG. 23. Subsequently, the computer viewable views then notify the registry 61 of the changes. Referring now to FIG. 24, it will be seen that the registry 61 is also updated and maintained as old views 94 are removed and new ones 95 are added. The new view name in the database framework 91 is stored in the database 90 (FIG. 1). In the arrangement as shown, each of the computer viewable views or formats 40 provides specific functionality that can stand alone. Each computer viewable view or format 40 is also configured so as to display data in the most appropriate format. These respective views or formats 40 may contain forms, lists, charts, etc. and the nature of the data will determine the display format. Most importantly perhaps, the computer viewable views as seen in the various drawings are dynamically interlinked. In this regard, changing any of the analysis parameters 60, or for that matter focusing, for example, on one view, through, for example, point and click functionality, will automatically cause all other related views 40 to change. In this regard, the other computer viewable views or formats 40 will requery and then display specific data related to the item of interest. In this regard, linking information from multiple sources in this way allows predefined analysis questions to be answered automatically. Still further, it eliminates the needs for linear data queries. As earlier discussed for example, clicking on a specific data point within a graph or a chart will cause all related views 40 to concurrently refocus on the data related to that point, thereby enhancing an analyst ability to quickly see trends, patterns, details and hidden relationships within the data which is displayed and which has not been possible heretofore.

### Operation

The operation of the described embodiment of the present invention is believed to be readily apparent and is briefly summarized at this point.

In its broadest aspect, an information analysis method of the present invention 10 includes as a first step providing a data analysis framework 91 for selectively holding a plurality of interrelated computer viewable views or formats 40 of selected data; interacting the plurality of computer viewable views 40; and evaluating the plurality of computer viewable views substantially simultaneously. More specifically, the information analysis method 10 of the present invention includes as a first step, defining a database 90 having information from various sources 1, and wherein the information from the various sources can be displayed in a plurality of different computer viewable formats 40. Still further, the methodology includes a step of selecting a plurality of parameters 60 which are common to the information which has been derived from the various sources 11; and interrelating the different formats 40, and the plurality of parameters 60 in a fashion so as to permit a user 13 to display selected related information derived from the variety of different sources in a plurality of different formats 40. In connection with the methodology described above, before the step of defining a database the method further includes a step of providing an application server 31; providing a database server 30, and wherein the database 90 is defined within the database server; and providing a software registry 61 and coupling the software registry 61 in data exchanging relation relative to the application server 31, and the database server 20. In the methodology 10 as described above, the methodology further includes a step of providing a web browser 15, and which is coupled in data exchanging relation relative to the application and database servers 31 and 30, respectively, and wherein the user or customer 13 may remotely access the web server to gain access to the application and database servers. In the methodology 10 of the present invention, the method further includes a step of defining a software interface 62 which is coupled in data exchanging relation relative to the software registry 61, and wherein the software interface 62 produces a computer viewable display showing the format 40 of the user selected and related information. In the methodology as described, the user or customer 13 may remotely access the application and database servers 31 and 30, respectively to modify the selected computer viewable views or formats 40 in which the information provided by the database 90 is displayed, and further to modify individual parameters 60 which are common to the information which has been derived from the various sources 11. As earlier discussed, modifying the individual parameters 60 has the effect of substantially simultaneously changing substantially all the computer viewable formats 40. As earlier discussed, the plurality of parameters 60 have a relationship with at least some of the plurality of different computer views or formats 40.

Before the step of remotely accessing the application and database servers 31 and 30, respectively, the methodology 10 of the present invention includes the steps of selecting the desired computer viewable formats 40 for displaying the information from the various sources; subscribing the selected computer viewable formats 40 to a software registry 61; and notifying the selected computer viewable formats 40 by way of the software registry 61 that the selected plurality of parameters 60 have predetermined values. In connection with the step of notifying the selected computer viewable formats 40 by way of the software registry 61, the method 10 further includes a step of retrieving the selected ones of the plurality of parameters 61 that are required by the individual computer viewable formats to display the information from the various sources 11. In connection with the step of retrieving selected ones of the plurality of parameters as discussed above, the methodology further includes the steps of first, updating the plurality of parameters 61 with new parameters 60 containing new information from the various sources 11; and second, updating the respective computer viewable formats 40 with the new information which has been derived from the new parameters 60. This updating of the respective selected computer viewable formats 40 may occur substantially synchronously or asynchronously based upon the specific data and display selected by the customer 13. In the methodology as provided for herein, the method 10 further includes a step of interacting with at least one of the plurality of parameters 60 and/or one of the plurality of computer viewable formats 40 to change the parameter 60 and/or the computer viewable format 40; updating the software registry 61 to reflect the change in the at least one of the parameters 60 and/or the computer viewable format 40; and changing the computer viewable formats 40 which are affected by the change in the at least one of the parameters 60 and/or computer viewable formats 40. As earlier discussed, the plurality of interrelated computer viewable views or formats 40 may be added, at will, by a user 13 to the data analysis framework 91.

Therefore, the information analysis method of the present invention 10 includes the steps of providing an application server 31; providing a database server 30; providing a software registry 61 and coupling the software registry 61 in data exchanging relation relative to the application and database servers. Still further the methodology 10 includes the steps of providing a web browser 15, and coupling the web browser in data exchanging relation relative to each of the application and database servers 31 and 30, and wherein a user or customer 13 may remotely access the application and database servers by employing the web browser. Still further, the method 10 includes the step of defining a database 90 within the database server 30 and which includes information from various sources 11, and wherein the information from the various sources can be displayed in a plurality of different computer viewable views or formats 40. Still further, the method 10 of the present invention includes the step of identifying a plurality of parameters 60 which have a relationship with at least some of the information which is derived from the various sources 11, and at least some of the plurality of computer viewable views or formats 40. Still further, the method 10 includes the steps of selecting the desired computer viewable formats 40 for displaying the information from the various sources; and subscribing selected ones of the computer viewable formats to the software registry 61. Still further, the method 10 of the present invention additionally includes the steps of retrieving the selected ones of the parameters 60 that are required by the individual computer viewable formats to display the information from the various sources 11; and interacting with at least one of the plurality of parameters 60 and/or plurality of computer viewable formats 40 to change the parameter 60 and/or the computer viewable format. Still further, the methodology includes a step of updating the software registry 61 as needed to reflect the change in at least one of the parameters 60 and/or the computer viewable format 40; and changing the respective computer viewable formats 40 which are affected by the change in the at least one of the parameters 60 and/or computer viewable formats 40. In the methodology 10 described above, the method also includes a step of providing a data analysis framework 91 for selectively holding the plurality of different computer viewable formats; and interrelating the plurality of computer viewable formats within the data analysis framework. Still further, in the methodology as discussed above, the different computer viewable formats 40 include charts 44, maps 46, graphs 45, and detailed record information. In the arrangement as shown, at least one of the different computer viewable formats 40 has a drill-down capability 65.

Therefore it will be seen that the methodology of the present invention provides a convenient means whereby an analyst, customer or user can evaluate a variety of information which is displayed simultaneously, and wherein the methodology assists the user in seeing trends, patterns, details and hidden relationships in the data which have heretofore only been determined by using complex queries and other analysis methods which have been time consuming and sometimes ineffective.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. An information analysis method, comprising:
providing a data analysis framework for selectively holding a plurality of interrelated computer viewable views of selected data;
interacting the plurality of computer viewable views; and
evaluating the plurality of computer viewable views substantially simultaneously.

2. An information analysis method as claimed in claim 1, and wherein the plurality of interrelated computer viewable views may be added, at will, by a user to the data analysis framework.

3. An information analysis method as claimed in claim 2, and wherein the computer viewable views may include charts, maps, graphs, lists and detailed record information.

4. An information analysis method as claimed in claim 3, and wherein at least one of the plurality of interrelated computer viewable views has a drill-down capability.

5. An information analysis method as claimed in claim 3, and wherein the step of interacting the plurality of computer viewable views further comprises:
querying one of the plurality of computer viewable views for more information regarding the data which is the subject of the query; and
updating all remaining computer viewable views to display specific other data which is related to the data which was the subject of the query.

6. An information analysis method as claimed in claim 5, and further comprising:
defining a database which resides on a database server and which contains the universal locators for the plurality of interrelated computer viewable views, which reside in the application server; and
providing an application server and which is coupled in data exchanging relation relative to the database server, and wherein the data analysis frame work resides on the application server.

7. An information analysis method as claimed in claim 6, and further comprising:
providing a software registry and coupling the software registry in data exchanging relation relative to the database and application servers.

8. An information analysis method as claimed in claim 7, and wherein the step of defining the database further comprises:
selecting a plurality of parameters which are common to the data which forms the respective computer viewable views, and wherein interacting with, or changing a selected one of the plurality of parameters has the substantially immediate effect of updating all the computer viewable views.

9. An information analysis method as claimed in claim 8, and further comprising:
providing a web browser which is coupled in data exchanging relation relative to the application and database servers, and wherein a remote user may access a web server to gain access to the application and database servers.

10. An information analysis method, comprising:
defining a database having information from various sources, and wherein the information from the various sources can be displayed in a plurality of different computer viewable formats;
selecting a plurality of parameters which are common to the information which has been derived from the various sources; and
interrelating the different formats, and the plurality of parameters in a fashion so as to permit a user to display selected related information derived from the variety of different sources in a plurality of different formats.

11. An information analysis method as claimed in claim 10, and wherein before the step of defining the database, the method further comprises:
providing an application server;
providing a database server, and wherein the database is defined within the database server; and
providing a software registry and coupling the software registry in data exchanging relation relative to the application server, and the database server.

12. An information analysis method as claimed in claim 11, and further comprising:
providing a web browser, and which is coupled in data exchanging relation relative to the application and database servers, and wherein the user may remotely access the web server to gain access to the application and database servers.

13. An information analysis method as claimed in claim 12, and further comprising:
defining a software interface which is coupled in data exchanging relation relative to the software registry, and wherein the software interface produces a computer viewable display showing the format of the user selected and related information.

14. An information analysis method as claimed in claim 13, and wherein the user may remotely access the application and database servers to modify the selected formats in which the information is displayed, and modify individual parameters which are common to the information which has been derived from the various sources, and wherein modifying the individual parameters has the effect of substantially simultaneously changing substantially all the computer viewable formats.

15. An information analysis method as claimed in claim 14, and wherein the plurality of parameters have a relationship with at least some of the plurality of different computer viewable formats.

16. An information analysis method as claimed in claim 15, and wherein the plurality of parameters do not have a relationship with the plurality of different computer viewable formats.

17. An information analysis method as claimed in claim 16, and wherein before the step of remotely accessing the application and database servers, the method further comprises:
selecting the desired computer viewable formats for displaying the information from the various sources;
subscribing the selected computer viewable formats to the software registry; and
notifying the selected computer viewable formats by way of the software registry that the selected plurality of parameters have predetermined values.

18. An information analysis method as claimed in claim 17, and wherein the step of notifying the selected computer viewable formats by way of the software registry further comprises:
retrieving the selected ones of the plurality of parameters that are required by the individual computer viewable formats to display the information from the various sources.

19. An information analysis method as claimed in claim 18, and wherein after the step of retrieving selected ones of the plurality of parameters, the method further comprises:
first, updating the plurality of parameters with new parameters containing new information from the various sources; and
second, updating the respective computer viewable formats with the new information which has been derived from the new parameters.

20. An information analysis method as claimed in claim 19, and wherein the updating of the respective selected computer viewable formats occur substantially synchronously.

21. An information analysis method as claimed in claim 20, and wherein the updating of the respective selected computer viewable formats occur substantially asynchronously.

22. An information analysis method as claimed in claim 21, and wherein the method further comprises:
interacting with at least one of the plurality of parameters and/or one of the plurality of computer viewable formats to change the parameter and/or the computer viewable format;
updating the software registry to reflect the change in the at least one of the parameters and/or the computer viewable format; and
changing the computer viewable formats which are affected by the change in the at least one of the parameters and/or computer viewable formats.

23. An information analysis method, comprising:
providing an application server;
providing a database server;
providing a software registry and coupling the software registry in data exchanging relation relative to the application and database servers;
providing a web browser and coupling the web browser in data exchanging relation relative to each of the application and database servers, and wherein a user may remotely access the application and database servers by employing the web browser;
defining a database within the database server and which includes information from various sources, and wherein the information from the various sources can be displayed in a plurality of different computer viewable formats;
identifying a plurality of parameters which have a relationship with at least some of the information which is derived from the various sources, and at least some of the plurality of computer viewable formats;
selecting the desired computer viewable formats for displaying the information from the various sources;
subscribing selected ones of the plurality of computer viewable formats to the software registry;
retrieving the selected ones of the parameters that are required by the individual computer viewable formats to display the information from the various sources;
interacting with at least one of the plurality of parameters and/or plurality of computer viewable formats to change the parameter and/or the computer viewable format;
updating the software registry as needed to reflect the change in at least one of the parameters and/or computer viewable format; and
changing the respective computer viewable formats which are affected by the change in the at least one of the parameters and/or computer viewable formats.

24. An information analysis method as claimed in claim 23, and further comprising:
providing a data analysis framework for selectively holding the plurality of different computer viewable formats; and
interrelating the plurality of computer viewable formats within the data analysis framework.

25. An information analysis method as claimed in claim 24, and wherein the different computer viewable formats include charts, maps, graphs, and detailed record information.

26. An information analysis method as claimed in claim 25, and wherein at least one of the different computer viewable formats has a drill-down capability.

27. An information analysis method as claimed in claim 26, and wherein the plurality of different computer viewable formats may be added and/or deleted at will by a user to the data analysis framework.
